(19) United States
(12) Patent Application Publication
(10) Pub. No.: US 2006/0136626 A1
(43) Pub. Date: Jun. 22, 2006

(54) Reconfigurable input/output interface

(76) Inventors: Steven A. Avritch, Bristol, CT (US); Richard A. Poisson, Avon, CT (US); Ronald P. Bauer, Windsor Locks, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/016,277

(22) Filed: Dec. 17, 2004

(51) Int. Cl. G06F 13/38

(52) U.S. Cl. 710/69

(57) ABSTRACT

A reconfigurable interface provides device-specific processing through software rather than hardware. The reconfigurable interface that samples an output from at least one device and converts it to a digital signal. The digital signal can then be processed in any desired manner, such as to extract intelligence or condition the signal. The conversion and the processing are controlled by data in a configuration table, which are easily modified and reconfigured to accommodate different systems and devices. The same reconfigurable interface can be used for any type of device and the devices do not require customized hardware interfaces to communicate with a signal processor.

### TECHNICAL FIELD

The present invention relates to interfaces, and more particularly to a system that can handle inputs and outputs having different formats.

### BACKGROUND OF THE INVENTION

In devices with complex computer systems, such as aircraft and automobiles, multiple devices, such as sensors, loads and actuators, a variety of sensing devices are used to monitor various components in the system. The output of the various devices are then sent to a central computer for analysis and/or output to a user. Due to the number of characteristics that must be monitored and controlled in such systems, the number and types of devices can vary widely. Moreover, different device types may generate outputs having different encoding and/or electrical formats. For example, a single system may have device that generate outputs in the form of a variable DC analog voltage, variable AC analog voltage, discrete on/off signal, variable frequency, variable AC phase, and/or variable resistance.

To handle these different output formats, currently known systems use custom interface circuits that extract intelligence from the device and convert the intelligence into an output that the central computer can use. An analog device output would, for example, be normally sent to a demodulator, then conditioned through a filter before being converted into a digital signal that is sent through a data bus to the central computer. The different electrical formats of the device outputs requires each device to have its own demodulator and conditioning circuitry to extract the device's intelligence and convert the output into digital form for processing. Thus, the physical hardware interface between the device and the computer will be different on a sensor-by-sensor basis, making it difficult to reuse the hardware if the devices are changed even minimally.

The location of the central computer can vary based on the overall system design, and this, in combination with the custom interface circuits, makes it difficult to use one standard computer system design for multiple systems. Any variations in the devices of the vehicle or aircraft, for example, necessitates a redesign and hardware reconfiguration of the computer system, resulting in inefficiencies in cost, weight, size, and performance attributes of the system. Reconfiguring the system hardware may also require the central computer to be removed completely from a given location to accommodate the hardware reconfiguration.

There is a desire for a system that can be reconfigured to accommodate a variety of different signal formats without requiring hardware changes or redundant design to accommodate the different formats. There is also a desire for an interface that can be used in different systems having varying numbers and types of devices without requiring extensive modification of the hardware in the interface.

### SUMMARY OF THE INVENTION

The present invention is directed to a reconfigurable interface that allows device-specific processing to be performed in software rather than hardware. The reconfigurable interface includes an analog-to-digital converter that samples an output at high speed from at least one device to convert the output into a digital signal. The digital signal can then be processed in any desired manner, such as to extract intelligence and/or condition the signal. The conversion and the processing are controlled by data entered into a configuration table. The configuration table can easily be modified if the devices in a given system are changed or if the reconfigurable interface is used in a different system.

Because the reconfigurable interface converts the device outputs before they are processed in any manner, the same reconfigurable interface can be used for any type of device and the devices do not require customized hardware interfaces to communicate with a signal processor. Thus, any system reconfiguration can be conducted simply through software modification rather than hardware modification.

### BRIEF DESCRIPTION OF THE DRAWINGS

FIG. 1 is a block diagram illustrating a system having a reconfigurable interface according to one embodiment of the invention;

FIG. 2 is a representative diagram illustrating a general process carried out by the system in FIG. 1;

FIG. 3 is a block diagram illustrating the system of FIG. 1 in more detail.

### DETAILED DESCRIPTION OF THE EMBODIMENTS

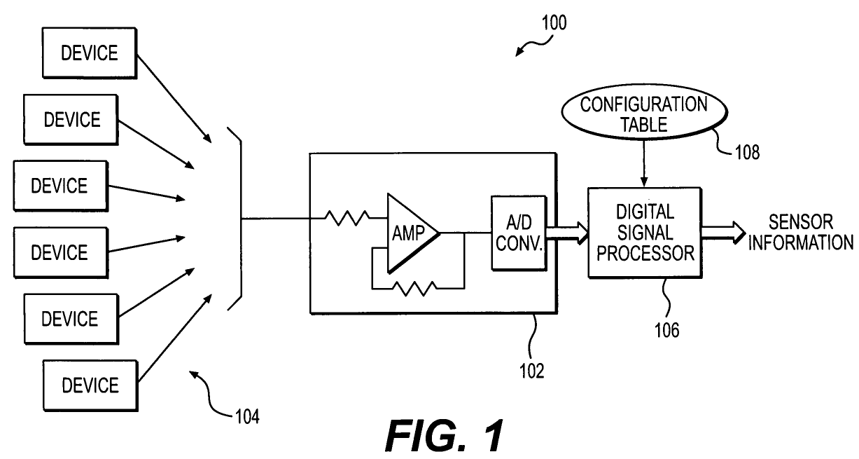

FIG. 1 is a representative block diagram illustrating a system 100 incorporating a reconfigurable interface 102. The reconfigurable interface 102 links devices 104 (e.g., sensors, actuators, loads, etc.) to a digital signal processor 106, which in turn generates an output based on the device information and information in a configuration table 108. Generally, the reconfigurable interface 102 acts as a universal signal conditioner that digitizes outputs having different formats so that they can be processed in the signal processor 106 without requiring hardware customization of the reconfigurable interface 102 or any other components. The reconfigurable interface 102 can also convert digital signals into analog signals to be sent back to the devices 104, if desired. In other words, data in the configuration table 108 configures the reconfigurable interface 102 to be compatible with the devices 104 so that the device outputs can be converted into a usable format, regardless of the original format of the device output.

The reconfigurable interface 102 therefore allows the devices 104 to be changed, removed, and/or added without requiring any hardware reconfiguration to accommodate the new device 104 configuration. Instead, the configuration table 108 can be modified via any known method (e.g., through a user interface 110 on a computer) to handle the device changes. Also, the reconfigurable interface 102 can be easily expanded and contracted to handle different numbers of devices 104 without requiring hardware modifications to the system 100.

The configuration table 108 itself include any data that may be used to convert inputs and outputs of the devices 104 into usable form and to extract intelligence from the devices 104. For example, the configuration table 108 may include, but is not limited to, pre-processing and post-processing instructions, individual device parameters and ranges, device voltages, filter types, parameters, sampling rates, etc. Inputs can be reconfigured for any sensor within operable limits, and outputs can be reconfigured for any load within operable limits. Moreover, pins on the devices 104 can be configured as either inputs or outputs, depending on the overall configuration of the system 100. The information that could be included in the configuration table 108 is essentially limitless because converting the device outputs into the digital domain without losing any quality of information provides a great deal of flexibility as to how they can be processed and evaluated. For example, if a user wishes to apply a particular filter on a device output, the characteristics of the desired filter can simply be entered into the configuration table 108. This is much more flexible than building an actual customized filter in hardware.

The reconfigurable interface 102 allows the same signal processor 106 and general hardware configuration to be used in multiple systems 100 having different devices 104. Moreover, each device 104 no longer requires its own unique hardware channel to convert the information from the device 104 into digital form to be usable by the signal processor 106.

As noted above, different devices 104 may generate outputs having different formats. As is known in the art, input sensors for electrical systems fall in several different categories and output intelligence in different formats. For example, speed and pressure sensors may generate outputs in a frequency signal format, while a potentiometer may generate an output as a DC voltage. Other possible output formats for both sensors and loads include, but are not limited to, variable resistance, AC or DC voltage/current, discrete on/off signals, pulse width modulated signals, and amplitude modulated signals. Those of skill in the art will recognize that the specific format of the output generated by the devices 104 is not critical to the scope of the invention.

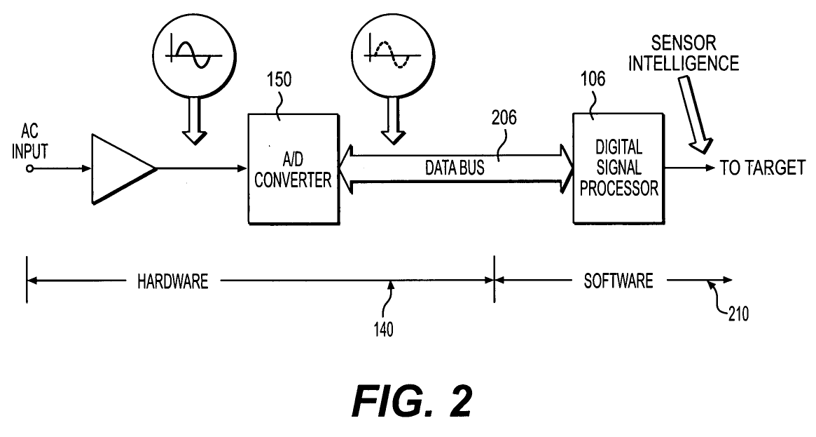

FIG. 2 illustrates the operation of the reconfigurable interface 102 in greater detail. The devices 104 and the reconfigurable interface 102 act as a hardware side 140 of the system 100. The reconfigurable interface 102 first receives outputs from the devices 104 and converts the outputs into digital form immediately in an A/D converter 150, without extracting intelligence from the output. To do this, the reconfigurable interface 102 samples the outputs at a rate fast enough to interpolate the original waveform. The Nyquist Theory states that the sampling frequency needs to be at least twice the absolute maximum frequency that the output can reach to recover all pertinent signal information (i.e., peaks and troughs in the signal). Note that the reconfigurable interface 102 may also include a D/A converter 152 to convert digital signals into an analog format usable by a given device 104. The high speeds of currently available A/D converters (for collecting inputs form the devices 104), D/A converters (for controlling output signals) and processors (e.g., the signal processor 106 and CPUs) allow sampling at rates that satisfy the Nyquist Theory. Thus, it is possible to convert the analog outputs from the devices 104 into digital form without losing any of the information in the outputs if the outputs are sampled at a rate that is at least the Nyquist sampling rate.

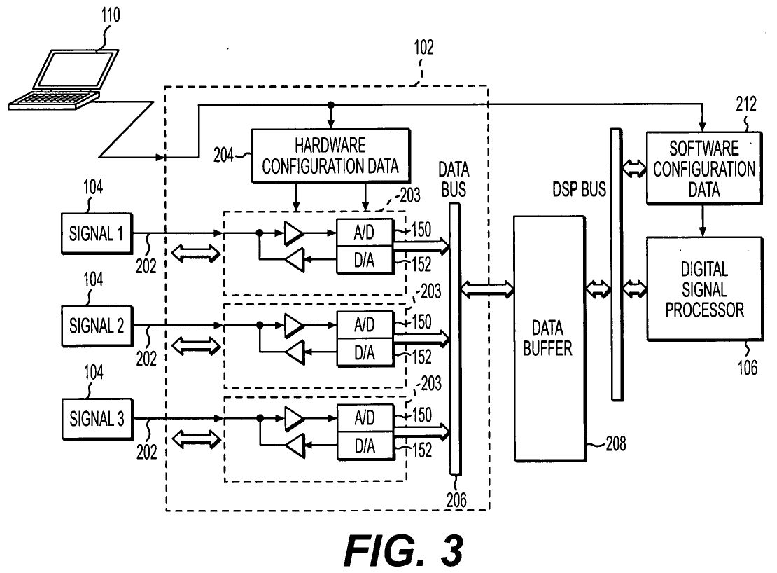

Referring to FIGS. 2 and 3, each device has an associated reconfigurable input/output hardware channel, each channel having an associated signal line 202 and a converter 203 in the reconfigurable interface 102. The converter 203 may include the A/D converter 150 and/or the D/A converter 152. Each hardware channel is reconfigurable through hardware configuration data 204 in the configuration table 108. The user interface 110 allows the data in the configuration table 108 to be easily changed so that the system 100 can accommodate changes in the number, location, type and output formats of the devices 104 without requiring any reconfiguration in the hardware.

The reconfigurable interface 102 then sends the sampled, digitized device output through a data bus 206 into a data buffer 208. The data buffer 208 and the signal processor 106 serve as a software side 210 of the system 100. The signal processor 106 then extracts intelligence from the sampled device outputs based on software configuration data 212 in the configuration table 108. The extracted intelligence may be sent to a target (not shown) for further action. Extracting intelligence from the device output on the software side 210 rather than the hardware side 140 further eliminates the need for any hardware reconfiguration if the devices 104 change because reconfiguration is conducted through software modifications (i.e., changing data in the configuration table 108) rather than hardware modifications. Because the signal processor 106 is fast enough to support complex algorithms, it can conduct virtually any desired processing of the device outputs to obtain the needed intelligence from the devices and, if desired, provide the devices 104 with information in their respective compatible signal formats as well.

As a result, the inventive reconfigurable interface allows the system to be reconfigured to accommodate a variety of sensors having different input/output formats without requiring any hardware modification. Also, the same reconfigurable interface can be used on multiple systems having differing numbers and types of devices without requiring any hardware reconfiguration in the system itself.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A reconfigurable interface for a system, comprising:
at least one hardware channel, each hardware channel corresponding with at least one device in the system and having a converter and a signal line for connecting the converter to said at least one device, wherein the converter converts at least one of an input and an output of said at least one device; and
a configuration table containing data that configures said at least one hardware channel to be compatible with said at least one device.

2. The reconfigurable interface of claim 1, wherein the converter comprises an analog-to-digital (A/D) converter that converts an analog output from said at least one device into a digital signal.

3. The reconfigurable interface of claim 2, wherein the A/D converter converts the analog output by sampling the analog output at a rate that is at least a Nyquist sampling rate.

4. The reconfigurable interface of claim 1, wherein the converter comprises a digital-to-analog (D/A) converter that converts a digital signal into an analog input to said at least one device.

5. The reconfigurable interface of claim 1, wherein said at least one hardware channel comprises a plurality of hardware channels corresponding to a plurality of devices.

6. The reconfigurable interface of claim 5, wherein said plurality of devices generates outputs having at least two different formats.

7. The reconfigurable interface of claim 1, further comprising a user interface that communicates with the configuration table to allow modification of the data in the configuration table.

8. The reconfigurable interface of claim 1, wherein the configuration table comprises hardware configuration data that configures said at least one hardware channel and software configuration data that configures a signal processor that processes at least one of the input and the output of said at least one device.

9. A system, comprising:
a plurality of devices;
a signal processor; and
a reconfigurable interface coupled between said plurality of devices and the signal processor, the reconfigurable interface having
at least one hardware channel, each hardware channel corresponding to one of said plurality of devices and having a converter and a signal line connecting the converter to the device, wherein the converter converts at least one of an input and an output of the device, and
a configuration table containing data that configures said at least one hardware channel to be compatible with said at least one device; and
a user interface that communicates with the configuration table to allow modification of the data in the configuration table.

10. The system of claim 9, further comprising a data buffer in communication with the signal processor and the reconfigurable interface, wherein the data buffer stores information from at least one of the reconfigurable interface and the signal processor.

11. The system of claim 9, wherein the converter comprises an analog-to-digital (A/D) converter that converts an analog output from said at least one device into a digital signal.

12. The system of claim 11, wherein the A/D converter converts the analog output by sampling the analog output at a rate that is at least a Nyquist sampling rate.

13. The system of claim 9, wherein the converter comprises a digital-to-analog (D/A) converter that converts a digital signal into an analog input to said at least one device.

14. The system of claim 9, wherein said plurality of devices generates outputs having at least two different formats.

15. The system of claim 9, wherein the configuration table comprises hardware configuration data that configures the plurality of hardware channels and software configuration data that configures the signal processor.

16. The system of claim 9, wherein the signal processor extracts intelligence from the output of the device and outputs the intelligence to a target.
